(19) United States
(12) Patent Application Publication
(10) Pub. No.: US 2009/0034039 A1
(43) Pub. Date: Feb. 5, 2009

(54) IMAGE FORMING APPARATUS

(75) Inventor: Daisaku Moriwaki, Yokohama-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/179,191

(22) Filed: Jul. 24, 2008

(30) Foreign Application Priority Data
Aug. 3, 2007 (JP) 2007-203404

(51) Int. Cl. G02B 26/10

(52) U.S. Cl. 359/199

(57) ABSTRACT

An image forming apparatus includes a drive control unit configured to control drive of a vibrating mirror in such a manner that vibration of the vibrating mirror becomes a reference vibration; a determination unit configured to determine an equilibrium convergence state of the vibrating mirror driven by the drive control unit; and a correction unit configured to correct magnification of an image in one scanning interval based upon result of determination by the determination unit.

### BACKGROUND OF THE INVENTION

1. Field of the Invention

The present invention relates to an image forming apparatus that employs electrophotography.

2. Description of the Related Art

In the field of image formation using electrophotographic techniques, a further a reduction in size and cost is being sought.

For example, as a technique for implementing such a reduction in size and cost, the specification of Japanese Patent Application Laid-Open No. 07-175005 proposes a method of using a galvanometer mirror, which is manufactured using semiconductor manufacturing techniques, instead of the polygon mirror used conventionally. According to this method, an image is formed by scanning a laser beam in the main-scan direction by causing a mirror to vibrate at the resonance frequency of a galvanometer mirror. A galvanometer mirror is such that a reduction in mirror size can be achieved by using semiconductor manufacturing techniques, thereby allowing a number of mirrors to be fabricated at one time. A reduction in cost can be expected as a result.

Further, the specification of Japanese Patent Application Laid-Open No. 2005-208578 describes nested-type mirrors in which the scanning region utilized can be regarded as having a uniform angular speed, and in which the scanning angle can be enlarged. Since a corrective optical system can be constructed in small size and with a simple structure by relying upon such nested-type mirrors, such an arrangement is ideal for use as a scanning device in a compact, low-cost image forming apparatus.

However, in a case where a mirror is vibrated and deflected at a resonance frequency using the technique described above, a problem which arises is that the resonant vibration develops unevenness mainly owing to turbulence produced by air resistance at the time of resonant vibratory operation, and this leads to aperiodic jitter in the main-scan direction.

If the linear velocity of a scanning angle develops unevenness owing to the effects of air resistance or the like when scanning is performed using a vibrating mirror, then whenever one line is scanned, the timing at which a BD signal is detected develops jitter. As a result, when scanning is performed, the image formation position and magnification in the main-scan direction in which scanning is carried out become unstable at certain times and are not constant for every line. Consequently, if vertical lines are drawn in the sub-scan direction, as illustrated in FIG. 8, a shift gradually develops over a plurality of lines owing to jitter and the straight lines in the sub-scan (vertical) direction develop visible undulations at the center of the page or at positions where writing ends.

There is a technique that corrects for this deviation in image formation position due to jitter. Specifically, the state of scanning-beam drive is measured based upon a detection time obtained by measuring the BD signal from a light receiving element, obtaining a differential between the measured state of drive and a target state of drive, and applying feedback gain to a driving circuit based upon the differential, thereby achieving a correction to the target driving waveform. However, in a case where correction of drive by feedback is performed in order to correct for the effects of jitter produced at the time of resonant vibration, the elements constructing the driving circuit develop a delay and there is also a delay in current owing to inductance. Further, since there is a response delay in the driving unit from application of the impressed gain until the system settles down is the steady state upon passing through a transitory state, the correction for jitter solely by correcting drive is insufficient, and it is difficult to achieve a highly accurate correction.

### SUMMARY OF THE INVENTION

In view of the circumstances set forth above, the present invention seeks to provide an image forming apparatus capable of improving the accuracy with which a shift in image formation position is corrected.

In order to solve the foregoing problems, the present invention provides an image forming apparatus for irradiating a vibrating mirror with a light beam that has been modulated by an image signal synchronized to a pixel clock signal, scanning a photoconductor with a reflected scanning beam and forming an image, the apparatus comprising: a drive control unit configured to control drive of the vibrating mirror in such a manner that vibration of the vibrating mirror becomes a reference vibration; a determination unit configured to determine an equilibrium convergence state of the vibrating mirror driven by the drive control unit; and a correction unit configured to correct magnification of an image in one scanning interval based upon result of determination by the determination unit.

In accordance with the present invention, it is possible to improve the accuracy with which a shift in image formation position is corrected.

Further features of the present invention will become apparent from the following description of exemplary embodiments with reference to the attached drawings.

### BRIEF DESCRIPTION OF THE DRAWINGS

FIG. 1 is a block diagram illustrating the configuration of an image forming apparatus according to an embodiment of the present invention;

FIG. 2 is a block diagram illustrating the configuration of a beam deflecting device in the image forming apparatus shown in FIG. 1;

FIG. 3 is a diagram illustrating deflection angles (scanning angles) of the beam deflecting device in this embodiment;

FIG. 4 is a diagram illustrating a time change in scanning position of a light beam resulting from a vibrating mirror;

FIG. 5 is a block diagram illustrating the configuration of a drive controller shown in FIG. 1;

FIG. 6 is a block diagram illustrating the configuration of an image processing unit shown in FIG. 1;

FIG. 7 is a diagram useful in describing calculation of amount of correction of light-beam modulation according to this embodiment; and

FIG. 8 is a diagram illustrating undulation of straight lines in the sub-scan direction at the center of a page or at positions where writing ends according to the prior art.

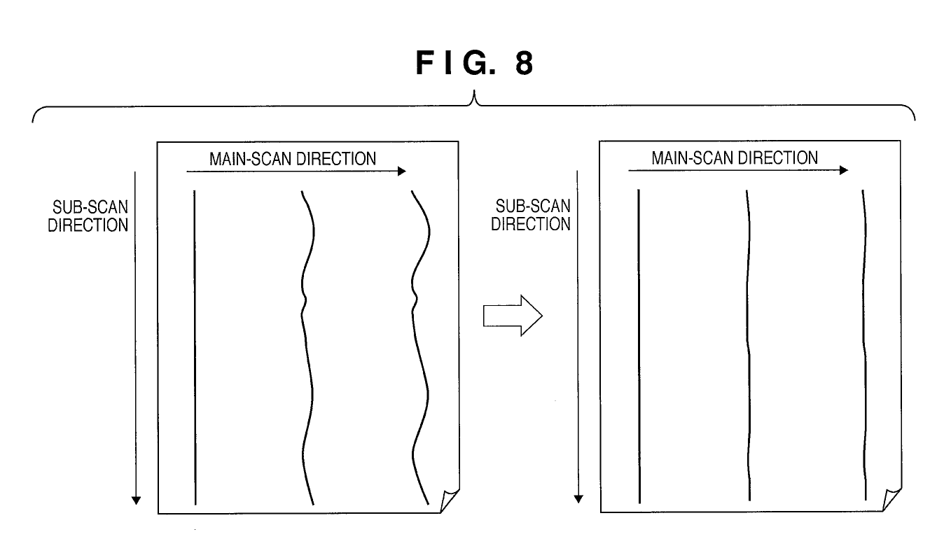

### DESCRIPTION OF THE EMBODIMENT

A preferred embodiment of the present invention will be described in detail with reference to the drawings. Identical structural elements are identified by identical reference characters.

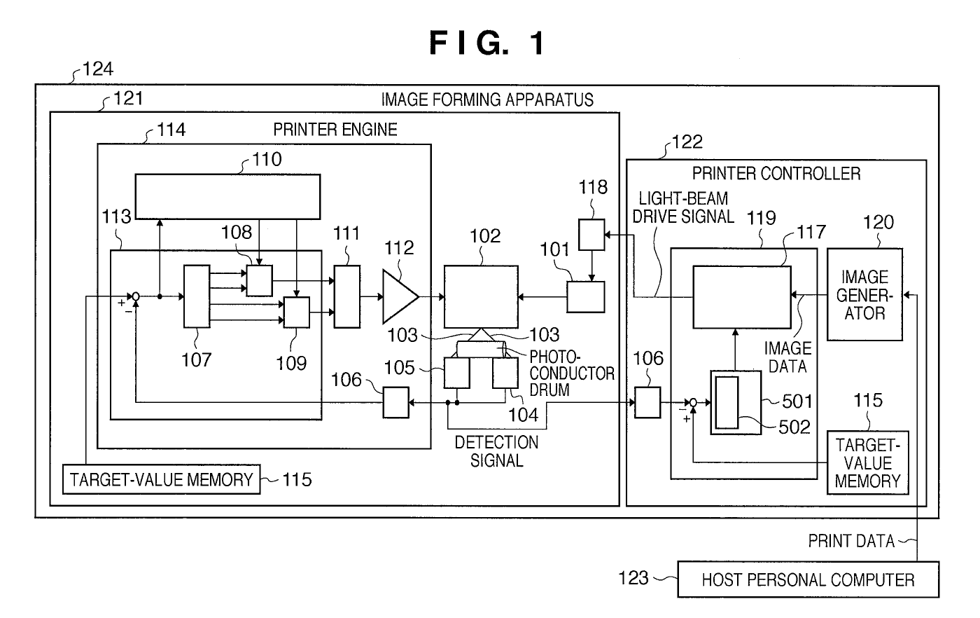

FIG. 1 is a block diagram illustrating the configuration of an image forming apparatus according to an embodiment of the present invention. A printer controller 122 controls the overall apparatus by a CPU (not shown) and generates a light-beam drive signal, which is capable of being output by a printer engine 121, from print data received from a host personal computer 123 that is external to the apparatus. An image generator 120 within the printer controller 122 analyzes the print data received from the outside by the printer controller 122, applies image processing, etc., and generates image data (also referred to as an “image signal”). Image data generated by the image generator 120 is output to a laser driver 118 in accordance with request timing of a vertical synchronizing signal that is output from the printer engine 121. As illustrated in FIG. 1, an image forming apparatus 124 according to this embodiment is so adapted that image correction by light-beam modulation in an image processing unit 119 and drive control by a drive controller 114 can be performed concurrently. The drive controller 114 and the image processing unit 119 will be described later. In this embodiment, the printer engine 121 transmits a detection signal to the printer controller 122 and receives the light-beam drive signal from the printer controller 122. However, it may be so arranged that the printer engine 121 calculates the amount of correction of light-beam modulation and drives the laser accordingly, by way of example. Further, as shown in FIG. 1, the image forming apparatus 124 includes a vibrating unit 102, a photoconductor drum, a first light receiving element 104 and a second light receiving element 105. The light beam, which has been modulated by image data synchronized to the pixel clock signal, irradiates a vibrating mirror contained in the vibrating unit 102, and the photoconductor drum is scanned by the reflected scanning beam, whereby image formation is carried out.

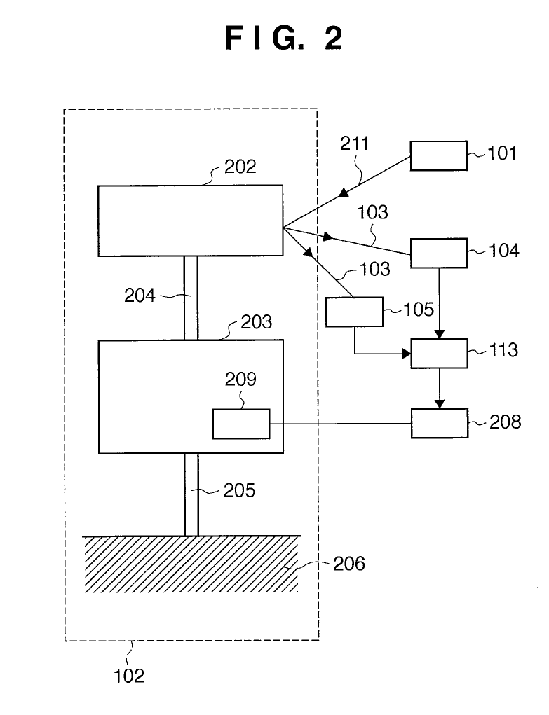

FIG. 2 is a block diagram illustrating the configuration of a beam deflecting device in the image forming apparatus shown in FIG. 1. FIG. 2 shows part of the structure of a beam scanner having one or more vibrating members for illuminating a reflecting mirror with the light beam and scanning the reflected beam. As illustrated in FIG. 2, the vibrating unit 102 of the beam deflecting device in this embodiment includes two vibrating elements and a plurality of torsion springs serially connecting the vibrating elements. The vibrating unit 102 is capable of producing first vibrational motion at a fundamental resonance frequency and second vibrational motion at a resonance frequency that is a integral multiple of the fundamental resonance frequency, the motions being isolated from each other. The beam deflecting device includes a controller 113 for operating the vibrating unit, a reflecting mirror formed on at least one vibrating element and a light source 101 for emitting a light beam 211, and illuminates the reflecting mirror with the light beam to thereby scan the beam. The vibrating unit 102 includes vibrating elements 202 and 203, a torsion spring 204 serially connecting the vibrating elements 202, 203, and a torsion spring 205 connecting the vibrating element 203 and a support member 206. The support member 206 supports a portion of the torsion spring. The controller 113 performs the role of a driving unit for transmitting a driving force to the vibrating element 203, wherein the driving force simultaneously excites a plurality of natural vibration modes of the vibrating unit 102 by electromagnetism, piezoelectricity or piezoelectricity, etc. In this embodiment, the controller 113 transmits a signal for controlling a current that flows through a coil 208. Owing to the current that flows through the coil 208, a torque acts upon a permanent magnet 209 attached to the vibrating member 203, thereby driving the vibrating unit 102. The vibrating element 202 has a reflecting mirror on the surface thereof and scans the light beam 211 from the light source 101. A scanning beam 103 passes by the first light receiving element 104 and second light receiving element 105 two times each in the back-and-forth scan of each cycle. Based on the times at which the scanning beam 103 passes by the first light receiving element 104 and second light receiving element 105 two times each, the controller 113 generates a control signal for passing a suitable current through the coil 208.

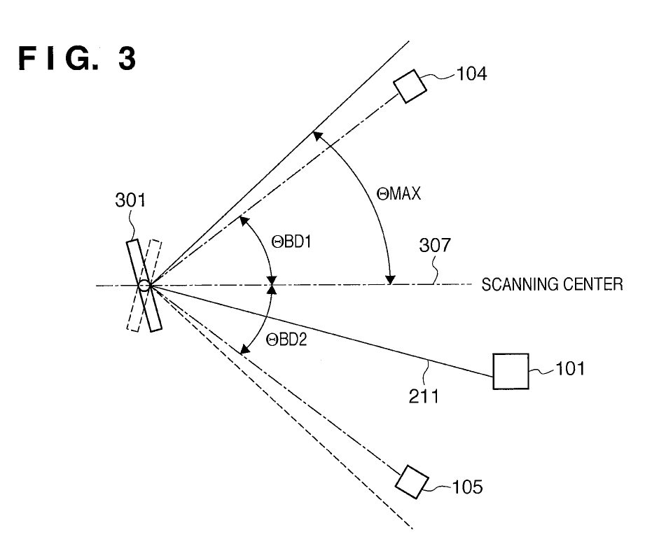

FIG. 3 is a diagram illustrating deflection angles (scanning angles) of the beam deflecting device in this embodiment. A vibrating mirror 301 has a reflecting mirror on the surface of a vibrating element can scans the light beam 211 from the light source 101. The beam deflecting device has the two light receiving elements 104 and 105. The first light receiving element 104 and second light receiving element 105 are placed at positions (θBD1 and θBD2, respectively) of deflection angles smaller than a maximum deflection angle θMAX of the beam deflecting device. The first light receiving element 104 and second light receiving element 105 are placed on the direct scanning optical path of the beam deflecting device, as illustrated in FIG. 3. In this embodiment, however, it may be so arranged that the first light receiving element 104 and second light receiving element 105 are placed on the optical path of a scanning beams deflected further by another reflecting mirror (reflecting member). The deflection angle θ of the beam deflecting device of this embodiment is measured with the position of a scanning center 307 serving as a reference, as shown in FIG. 3. In this embodiment, the deflection angle θ is represented by a vibrational waveform expressed by Equation (1) below in which the amplitude, angular frequency and phase of the first vibrational motion are represented by A1, ω1 and φ1, respectively, and the amplitude, angular frequency and phase of the second vibrational motion are represented by A2, ω2 and φ2, respectively.

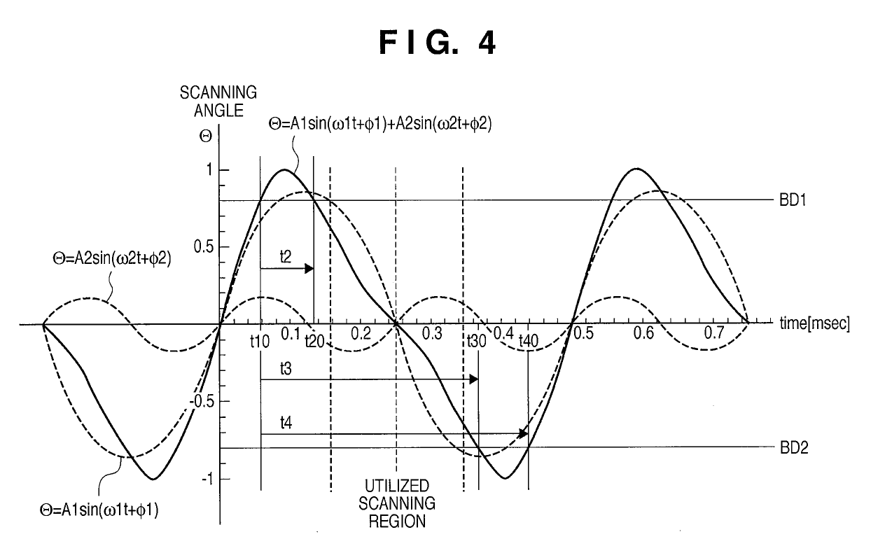

θ(t)=A1 sin(ω1t+φ1)+A2 sin(ω2t+φ2) (1)

where t is a variable representing time in a case where an appropriate time has been adopted as the origin or reference time. FIG. 4 is a diagram illustrating a time change in scanning position of a light beam resulting from a vibrating mirror. The vibrating mirror is converted from scanning at a substantially uniform velocity to scanning at a uniform linear velocity owing to a synthesis of two sinusoidal waveforms indicated by dashed lines, as illustrated in FIG. 4.

Further, the deflection angle θ of the beam deflecting device is represented by Equation (2) or Equation (3) below, in which the relative phase of the two frequencies is θ.

θ(t)=A1 sin(ω1t)+A2 sin(ω2t+f) (2)

θ(t)=A1 sin(ω1t+φ)+A2 sin(ω2t) (3)

For example, in a case where there is a possibility of controlling phase on the side of the first vibrational motion, Equation (3) applies. Although Equations (1), (2) and (3) differ in expression in terms of how the reference or time at the origin is taken, the equations are essentially the same in that they are equations containing the four unknown values (A1, A2, φ1, φ2). For example, φ in Equation (2) or (3) can be expressed as φ1−φ2 or φ2−φ1.

The first light receiving element 104 and second light receiving element 105 are placed at desired positions irradiated with the scanning beam. The four unknown values mentioned above are found by adjusting the amplitude and phase of the first and second vibrational motions in one period of the first vibrational motion in such a manner that the scanning beam will pass by the first light receiving element 104 and second light receiving element 105 at four desired times t that differ from one another. In this embodiment, any desired deflection angle θ of the beam deflecting device can thus be obtained. With regard to the four times t, Equation (4) below holds at prescribed times t1 and t2 assuming that the deflection angle corresponding to the positions of the first light receiving element 104 and second light receiving element 105 are θBD1 and θBD2, respectively.

θ(t1)=θ(t2)=θBD1 (4)

Further, Equation (5) below holds at prescribed times t3 and t4.

θ(t3)=θ(t4)=θBD2 (5)

By exercising control using the controller 113 in such a manner that the four times t1, t2, t3, t4 become desired times t10, t20, t30, t40, respectively, the amplitudes and phases of the first and second vibrational motions can be uniquely determined. More specifically, the controller 113 exercises control in such a manner that an appropriate current flows through the coil 208 such that each of the four times will take on any desired time, thereby controlling the amplitude, phase or relative phase of each of the first and second vibrational motions. It may be so arranged that in a case where the deflection angle of the beam deflecting device is expressed solely by either one of the terms in Equation (1), the amplitude and phase of the first or second vibrational motion are adjusted in such a manner that the scanning beam passes by the first light receiving element 104 and second light receiving element 105 at least at two of the desired times.

In this embodiment, the relative times of the four times t1, t2, t3, t4 are found in a case where the amplitudes of the first and second vibrational motions and the relative phase of the first and second vibrational motions are controlled. Specifically, let t10 be the reference time among target times t10, t20, t30, t40 at which the scanning beam 103 passes by the first light receiving element 104 and second light receiving element 105, by way of example. The driving signal is controlled by the driving unit in such a manner that three detection relative times t2−t1, t3−t1, t4−t1 at which the scanning beam 103 passes by the first light receiving element 104 and second light receiving element 105 become target relative times t20−t10, t30−t10, t40−t10. As a result, the amplitudes of the first and second vibrational motions and the relative phases of the first and second vibrational motions can be controlled. The time from target times t20 to t30 or the time from target times t40 to t10 is referred to as “reference scanning time”.

If we let time differences between the detection relative times and target relative times be represented by Δt2, Δt3, Δt4, then the time differences Δt2, Δt3, Δt4 are expressed by Equation (6) below.

Δti=ti−t10=(ti−t1)−(t10−t10) (6)

where i=1, 2, 3, 4 holds.

Next, a method of control by the controller 113 will be described in detail. In a case where a control parameter X that includes any of amplitudes A1, A2 and phase φ has changed slightly from the target value, coefficients and a matrix M representing a change in the detection relative times t2−t1, t3−t1, t4−t1 at which the scanning beam 103 passes by the first light receiving element 104 and second light receiving element 105 are found in advance. In this embodiment, these are represented by Equations (7) and (8) below. For example, these coefficients and the matrix M may be found by previously measuring a change in the amplitude Al from desired times t1 to t 2.

$$\begin{matrix}\frac{\partial t}{\partial X} {\vert}_{ti} - \frac{\partial t}{\partial X} {\vert}_{ti} , ( X = A 1 , A 2 , φ ) , ( i = 2 , 3 , 4 ) & ( 7 ) \\ M = ⌈ \begin{matrix}\frac{\partial t}{\partial A 1} {\vert}_{t 2} & - \frac{\partial t}{\partial A 1} {\vert}_{t 1} & \frac{\partial t}{\partial A 2} {\vert}_{t 2} & - \frac{\partial t}{\partial A 2} {\vert}_{t 1} & \frac{\partial t}{\partial φ} {\vert}_{t 2} & - \frac{\partial t}{\partial φ} {\vert}_{t 1} \\ \frac{\partial t}{\partial A 1} {\vert}_{t 3} & - \frac{\partial t}{\partial A 1} {\vert}_{t 1} & \frac{\partial t}{\partial A 2} {\vert}_{t 3} & - \frac{\partial t}{\partial A 2} {\vert}_{t 1} & \frac{\partial t}{\partial φ} {\vert}_{t 3} & - \frac{\partial t}{\partial φ} {\vert}_{t 1} \\ \frac{\partial t}{\partial A 1} {\vert}_{t 4} & - \frac{\partial t}{\partial A 1} {\vert}_{t 1} & \frac{\partial t}{\partial A 2} {\vert}_{t 4} & - \frac{\partial t}{\partial A 2} {\vert}_{t 1} & \frac{\partial t}{\partial φ} {\vert}_{t 4} & - \frac{\partial t}{\partial φ} {\vert}_{t 1}\end{matrix} ⌉ & ( 8 )\end{matrix}$$

Accordingly, controlled variables ΔA1, ΔA2, Aφ of amplitudes and phase of the vibrating mirror are found from Equation (9) below based upon time differences Δt2, Δt3, Δt4 between the detection relative times t2−t1, t3−t1, t4−t1 and target relative times t20−t10, t30−t10, t4−t10.

$$⌊ \begin{matrix}Δ A 1 \\ Δ A 2 \\ Δφ\end{matrix} ⌋ = {M}^{- 1} ⌊ \begin{matrix}Δ t 2 \\ Δ t 3 \\ Δ t 4\end{matrix} ⌋ \qquad ( 9 )$$

The controlled variables ΔA1, ΔA2, Δφ are calculated from the time differences Δt2, Δt3, Δt4 as indicated by the equations above, and the output of the controller 113 is changed based upon these values. By repeating the control described above, the detection relative times t2−t1, t3−t1, t4−t1 converge to the target relative times t20−t10, t30−t10, t 40−t10, and the desired deflection angle θ can be obtained as a result. In this embodiment, vibration based upon the desired deflection angle θ is adopted as reference vibration that is in accordance with prescribed equilibrium conditions.

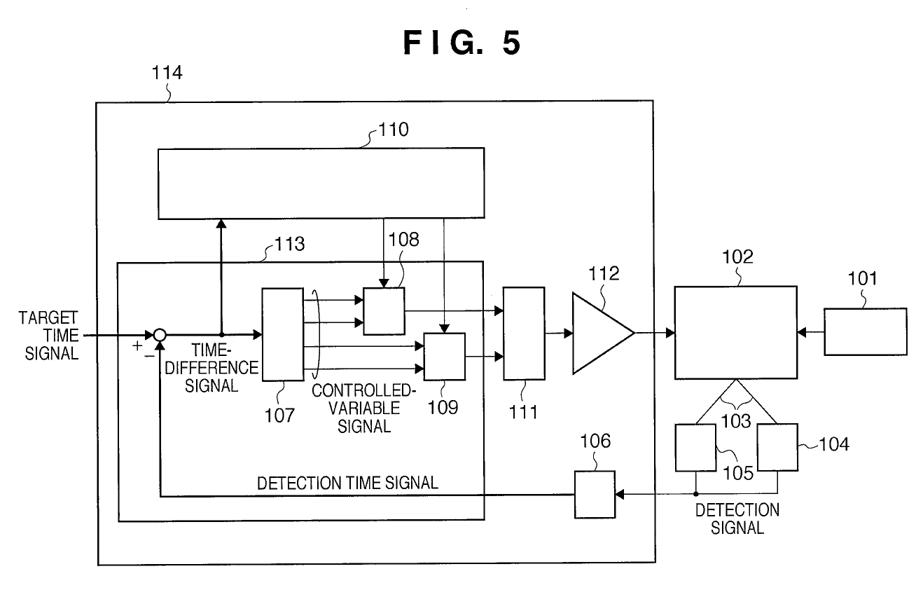

FIG. 5 is a block diagram illustrating the configuration of the drive controller shown in FIG. 1. By deflecting the light from the light source 101 using the vibrating unit 102, the scanning beam 103 passes by the first light receiving element 104 and second light receiving element 105. A time measuring counter 106 acquires detection time from detection signals obtained by the first light receiving element 104 and second light receiving element 105 and outputs the detection time signal to the controller 113 (vibration detecting means (a vibration detecting unit)). The controller 113 calculates a time-difference signal by taking the difference between the detection time indicated by the detection time signal and target time indicated by a target time signal that enters from a target-value memory 115, and outputs the time-difference signal as the result of detection to a control-gain adjusting unit 110 and arithmetic unit 107. Furthermore, a matrix computation is performed by the arithmetic unit 107 based upon the time-difference signal, as indicated by Equation (9), whereby a controlled-variable signal indicating a controlled variable it calculated. A control signal for passing an appropriate current through the coil of the vibrating unit 102 is generated by controllers 108, 109, an adder 111 and an amplifier 112. Accordingly, in the drive controller (drive control means (a drive control unit)) shown in FIG. 1, the vibrating mirror is controlled and the vibration of the vibrating mirror can be made a reference vibration that is in accordance with prescribed equilibrium conditions.

In a case where t10 is adopted as the reference time, the controlled variables (drive control parameters) applied to the controller 108 need not be two; a single controlled variable may be used. Alternatively, the controlled variables applied to the controller 109 need not be two; a single controlled variable may be used. In other words, the phase differences φ of the respective two frequencies can be adjusted by either the controller 108 or 109. Based on the time differences Δt2, Δt3, Δt4 indicated by the entered time-difference signals, the control-gain adjusting unit 110 outputs a signal for adjusting the control gains of the controller 108 and 109. In a case where a response delay has occurred in the drive controller 114 when the deflection angle φ stabilizes, the control-gain adjusting unit 110 senses this response delay and adjusts the gains of the controllers 108 and 109. Generally speaking, various response-delay compensating methods are used in the control-gain adjusting unit 110. For instance, in a case where there is a fixed rule for the response delay in the drive controller 114, the present gain of the controller is subjected to fixed weighting so as to compensate for the response delay, by way of example. Further, if the response delay varies in a time series, then a response-delay evaluation function having the time differences Δt2, Δt3, Δt4 as variables is used, whereby a signal for changing gain in such a manner that this evaluation function will become an optimum value is transmitted to the controller. However, if the control gain is changed in order to compensate for response delay, the vibrational state of the mirror becomes unstable and, as a consequence, a shift in the image formation position occurs.

In this embodiment, the arrangement shown in FIG. 5 additionally performs a correction based upon modulation of the light beam that irradiates the mirror portion of the vibration system. As a result, even if the control gain is changed and the vibrational state becomes unstable in the drive controller 114 shown in FIG. 5, for example, during this time the instability of the vibrational state due to the change in control gain can be compensated for by modulating the light beam. The image processing unit for performing a correction by modulating the light beam will now be described.

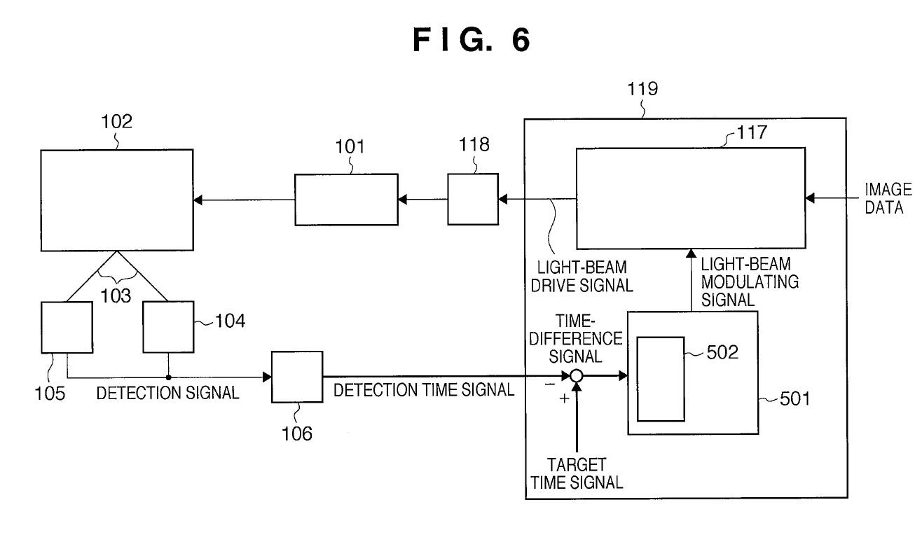

FIG. 6 is a block diagram illustrating the configuration of the image processing unit shown in FIG. 1. Owing to deflection of the light from the light source 101 by the vibrating unit 102, the scanning beam 103 passes by the first light receiving element 104 and second light receiving element 105. The time measuring counter 106 acquires detection time from detection signals obtained by the first light receiving element 104 and second light receiving element 105. The image processing unit 119 takes the difference between the detection time indicated by the detection time signal and target time indicated by a target time signal and calculates the time difference indicated by the time-difference signal.

A correction-amount prediction unit 501 predicts the amount of light-beam modulation correction for the next scan using the time differences Δt2, Δt3, Δt4 between the detection relative times detected and predetermined target relative times. The detection relative times detected are t2−t1, t3−t1 and t4−t1. The predetermined target relative times are t20−t10, t30−t10 and t 40−t10. When the prediction is made, the prediction may also be performed based upon the controlled variables ΔA1, ΔA2, Δφ, which have been calculated according to Equation (9), besides the time differences Δt2, Δt3, Δt4. In this case, the arithmetic unit 107 shown in FIG. 5 is placed in front of the correction-amount prediction unit 501 in FIG. 6 and the controlled-variable signal is input to the correction-amount prediction unit 501. Further, the correction-amount prediction unit 501 may predict the amount of light-beam modulation correction using time-difference information history from one scan earlier and may further perform a prediction by a method such as using an average value of a plurality of items of time-difference information history of more than one previous scan.

As illustrated in FIG. 6, the correction-amount prediction unit 501 includes a convergence-state determination unit 502. Based on the time differences Δt2, Δt3, Δt4 input thereto, the convergence-state determination unit 502 determines whether the vibrational state of the vibrating unit 102 is an equilibrium convergence state. If the detection time signal has become the target time signal, then a judgment can be made that the vibrational state of the vibrating unit 102 is such that the vibrating unit 102 is vibrating at the ideal deflection angle θ. In this embodiment, this vibrational state is referred to as “reference vibration”. Accordingly, if the entered time differences Δt2, Δt3, Δt4 are zero, by way of example, then it can be judged that the vibrational state of the vibrating unit 102 is the equilibrium convergence state (the means for this operation is also referred to as “equilibrium-convergence-state determination means (an equilibrium-convergence-state determination means)”). The non-equilibrium convergence state, which in a state in which equilibrium convergence has not been attained, is one in which the vibrational state is unstable, that is, in a transitory state, owing to start of drive, updating of the control gains of the controllers 108 and 109, etc.

Further, in order to additionally detect how much the vibrational state differs from the ideal vibrational state, the determination of convergence of the vibrational state of the vibration system may be performed based upon the evaluation function used in the control-gain adjusting unit 110 in the drive controller 114 of FIG. 5. For example, by using the evaluation function, the convergence-state determination unit 502 compares the target relative times t20−t10, t30−t10, t40−t10, which are the target values of convergence, and the entered time differences Δt2, Δt3, Δt4. In this case, the convergence-state determination unit 502 judges that the equilibrium convergence state has been attained if the result of the comparison is smaller than the value set by the evaluation function.

In this embodiment, the correction-amount prediction unit 501 adjusts the gain of the amount of light-beam modulation correction in accordance with the result of determination of the vibrational state of the vibrating unit 102. If the convergence-state determination unit 502 has determined that the vibrational state of the vibrating unit 102 is the non-equilibrium convergence state, then the correction-amount prediction unit 501 calculates the amount of light-beam modulation correction and performs the correction by modulating the light beam. Further, if the convergence-state determination unit 502 has determined that the vibrational state of the vibrating unit 102 is the equilibrium convergence state, then the correction-amount prediction unit 501 sets the light-beam modulation correction amount to zero and halts image correction based upon modulation of the light beam. In this case, the timing at which control is halted may be in the middle of scanning of a certain line or at the start of scanning of the next line. Here the modulation of the light beam is halted at the moment the vibrating unit 102 converges from the non-equilibrium convergence state to the equilibrium convergence state. However, it may be so arranged that the gain of the amount of light-beam modulation correction is changed and correction continued even after the vibrating unit 102 has converged to the equilibrium convergence state. Calculation of the amount of light-beam modulation correction will be described later.

Based on the amount of light-beam modulation correction calculated by the correction-amount prediction unit 501, a light-beam modulator 117 generates a light-beam driving signal for correcting overall magnification or partial magnification of the image data and controls the laser driver 118. It may be so arranged that the overall magnification and partial magnification are corrected by lengthening or shortening the pulse width of the light beam intermittently. Further, it may be so arranged that the overall magnification and partial magnification are corrected by lengthening or shortening the pulse width of the light beam at a uniform distribution. Further, it may be so arranged that the overall magnification and partial magnification are corrected by adjusting the frequency of a PLL circuit (not shown) that supplies the image clock.

In this embodiment, the magnification of the image in one scanning interval is corrected based upon the result of the determination concerning the equilibrium convergence state. That is, in the present image forming apparatus, in addition to correction of drive by the drive controller, the equilibrium convergence state of vibration of the vibrating element is determined and the image magnification correction is performed supplementarily based upon the result of the determination. The accuracy with which a shift in image formation position can be corrected is improved as a result. Various methods are known as image correction techniques, such as changing the frequency of the pixel clock signal or changing the phase by inserting a pixel fragment. One example of a method used in this embodiment will be described below.

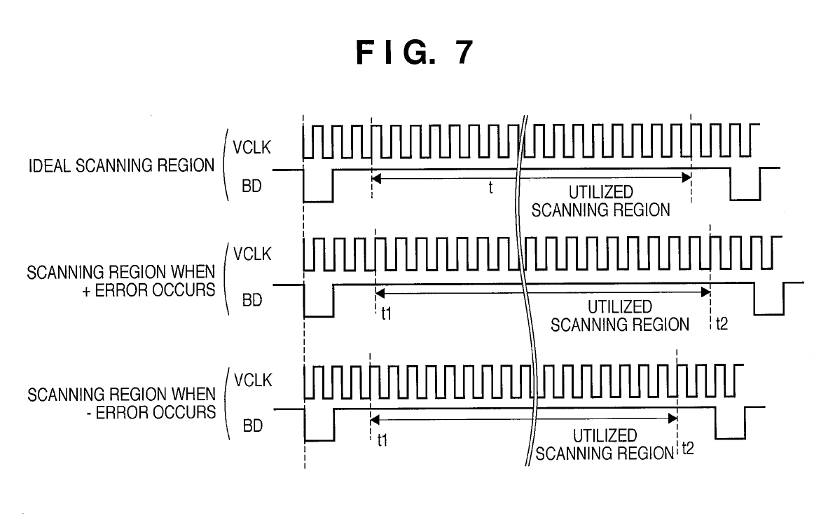

FIG. 7 is a diagram useful in describing calculation of amount of correction of light-beam modulation according to this embodiment. In this embodiment, rendering time is controlled by an image correction technique based upon the result of detecting the scanning beam 103 by the first light receiving element 104 and second light receiving element 105. Specifically, the accuracy with which a shift in image formation position is corrected is improved using the image correction by the image processing unit of FIG. 6 to supplement the correction processing by the drive controller shown in FIG. 5. The object of image correction processing according to this image processing unit is to hold the number of pixels between BD signals constant even in a case where an error of the kind shown in FIG. 7 has occurred in the intervals of the BD signal. This method will now be described.

FIG. 7 illustrates an ideal scanning region and signal waveforms in a case where the BD-signal interval has increased, that is, a case where scanning speed has slowed, owing to the effects of jitter, and in a case where the BD-signal interval has decreased, that is, a case where scanning speed has risen, owing to the effects of jitter. Letting “t” represent the ideal value of scanning time and “a” the ratio of jitter to the ideal value t of one scanning interval, “a” is found from Equation (10 below.

a=[t−(t2−t1)]/t (10)

where t1 and t2 are times detected as a utilized scanning region. Further, in this embodiment, the utilized scanning region is defined as a region extending from a point that is two clock pulses of a pixel clock signal VCLK beyond the rising edge of the BD signal to a point that is two clock pulses of the pixel clock signal VCLK short of the falling edge of the BD signal. In the image forming apparatus of this embodiment, the utilized scanning region may be used as the rendering time, or a new time interval that is based upon the interval of the utilized scanning region may be used as the rendering time.

As illustrated in FIG. 7, the number of edges of the pixel clock signal contained on the BD-signal interval also changes attendant upon the error that occurs in the BD-signal interval, and therefore an error develops in the number of pixels in the utilized scanning region. In this embodiment, therefore, the period of the pixel clock signal contained in the BD-signal interval is adjusted in accordance with the error that has occurred in the BD-signal interval, and the correction is performed in such a manner that the number of pixels in the utilized scanning region is held constant.

The adjustment of the number of edges of the pixel clock signal is carried out as follows, by way of example: Assume that t1 and t2 shown in FIG. 7 have been detected. The difference between the utilized scanning region “t2−t1” actually measured and the ideal utilized scanning region corresponds to the time difference between the detection relative time and target relative time described earlier. Accordingly, the extent to which the utilized scanning region actually measured is larger or smaller than the ideal utilized scanning region can be ascertained by the evaluation function in the convergence-state determination unit 502, by way of example.

Further, the number of edges “CN” (i.e., number of pixels) of the pixel clock signal contained in the ideal utilized scanning region is found beforehand from the period of the pixel clock signal and “t” illustrated in FIG. 7. Accordingly, if it is ascertained that the utilized scanning region “t2−t1” actually measured has developed an error with respect to the ideal utilized scanning region t, then the period of the pixel clock signal is found in such a manner that the number of edges (number of pulses) of the pixel clock signal will become the pixel count “CN” in “t2−t1”. The period of the pixel clock signal found is output to the light-beam modulator 117 as the light-beam modulation correction amount shown in FIG. 6. Upon receiving the information concerning the period of the pixel clock signal, the light-beam modulator 117 modulates the pixel clock signal using, for example, a PLL circuit (not shown). As a result, the number of pixels in the BD-signal interval can be held constant even in a case where an error of the kind shown in FIG. 7 has occurred.

In this embodiment, there is no particular limitation regarding the method of modulating the pixel clock signal, and other methods may be used. For example, an arrangement may be adopted in which phase is changed by inserting a pixel fragment at a specific location.

In this embodiment, as described above, a correction based upon modulation of the light beam is carried out by correction of drive relying upon feedback in the vibration system until the vibrational state of the vibrating unit 102 attains the equilibrium convergence state. Control is exercised by a correction based upon light-beam modulation in such a manner that the number of clock edges of the pixel clock signal, that is, the pixel count, within the utilized scanning region is rendered constant irrespective of jitter in the BD signal. As a result, it is possible to compensate for a response delay that accompanies a vibrational transitory state as caused by feedback gain in the vibration system, and the accuracy with which a shift in image formation position is corrected can be improved. A more accurate jitter correction can be performed as a result, and image formation position in the sub-scan direction can be maintained in excellent fashion at the center or ends of a transfer medium.

The beam deflecting device in this embodiment has the two light receiving elements, namely the first light receiving element 104 and second light receiving element 105, and these two light receiving elements two different scanning angles of the scanning beam 103. Two light receiving elements need not be employed in this embodiment. In FIG. 2, for example, an arrangement may be adopted in which a reflecting plate is constructed at the position of the second light receiving element 105, the scanning beam 103 is deflected by the reflecting plate and the deflected light beam is caused to pass by the first light receiving element 104 directly or via at least reflecting member. In this case, four times that differ from one another can be detected in one period of vibrational motion by using a single light receiving element. Furthermore, by adopting t1, t2, t3 and t4 as the respective four detected times in this case, the present invention can be applied as a beam deflecting device having only one light receiving element.

Further, the convergence-state determination unit 502 in this embodiment may determine the convergence state of vibration of the vibration system without using the time differences Δt2, Δt3, Δt4 and controlled variables ΔA1, ΔA2, Δφ. For example, the convergence time necessary for drive control to reach the equilibrium convergence state following application of the gain in the feedback drive correction may be measured beforehand in the drive controller 114 and this may be stored in a storage area such as a memory as profile information indicating the characterizing features of the image forming apparatus. In this case, when the convergence time stored as the profile elapses from the moment of application of the gain in the feedback drive correction, the convergence-state determination unit 502 judges that the equilibrium convergence state has arrived and ends the image correction by the image processing unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-203404, filed Aug. 3, 2007, which is hereby incorporated by reference herein in its entirety.

What is claimed is:

1. An image forming apparatus for irradiating a vibrating mirror with a light beam that has been modulated by an image signal synchronized to a pixel clock signal, scanning a photoconductor with a reflected scanning beam and forming an image, the apparatus comprising:
a drive control unit configured to control drive of the vibrating mirror in such a manner that vibration of the vibrating mirror becomes a reference vibration;
a determination unit configured to determine an equilibrium convergence state of the vibrating mirror driven by said drive control unit; and
a correction unit configured to correct magnification of an image in one scanning interval based upon result of determination by said determination unit.

2. The apparatus according to claim 1, wherein the reference vibration has a constant linear velocity of the scanning beam in the time of one scan.

3. The apparatus according to claim 1, wherein said correction unit corrects a pixel count in one scanning interval to a pixel count in a reference scanning time of the reference vibration.

4. The apparatus according to claim 3, wherein said correction unit ends the correction by said correction unit by using the difference between the time of one scan and the reference scanning time.

5. The apparatus according to claim 3, wherein said correction unit ends the correction by said correction unit upon elapse of a convergence time measured beforehand and stored in a storage area as information indicating characterizing features of the image forming apparatus.

6. In a optical scanner constituted by a vibration system having one or more vibrating elements, one or more torsion springs connecting the vibrating elements and a support portion for supporting part of the torsion spring, a drive unit for transmitting driving force to the vibration system, a reflecting mirror formed in at least one of the vibrating elements, and a light source for generating a light beam, an image forming apparatus comprising:
a vibration detecting unit configured to detect the vibrational state of the vibration system;
a drive control unit configured to adjust the driving force by at least one drive control parameter, which conforms to at least one predetermined equilibrium condition, in accordance with result of detection by said vibration detecting unit, and control the vibration of the vibration system to the predetermined equilibrium condition;
an equilibrium-convergence-state determination unit configured to determine the equilibrium convergence state of the vibration system;
a correction-amount predicting unit configured to operate in accordance with result of the determination by said equilibrium-convergence-state determination unit and predicting an amount of correction of light-beam modulation in the next scan in order to correct at least one of amplitude jitter and phase jitter in a vibrational waveform of vibrational motion in the next scan; and
a light-beam modulating unit configured to modulate the light beam in accordance with the correction amount predicted by said correction-amount predicting unit and controlling rendering time.
